(19) United States
(12) Patent Application Publication
(10) Pub. No.: US 2026/0327408 A1
(43) Pub. Date: Oct. 22, 2026

(54) POLYHYDROXYALKANOATE-BASED COMPOSITIONS AND ARTICLES MADE THEREFROM

(71) Applicant: Newlight Technologies, Inc., Huntington Beach, CA (US)

(72) Inventors: Jeffery Leon, Huntington Beach, CA (US); Jose Brizuela, Huntington Beach, CA (US); Jon Knight, Huntington Beach, CA (US); Mohammad Badrossamay, Huntington Beach, CA (US)

(73) Assignee: Newlight Technologies, Inc., Huntington Beach, CA (US)

(21) Appl. No.: 19/114,094

(22) PCT Filed: Sep. 22, 2023
(86) PCT No.: PCT/US2023/033513

§ 371 Date: Mar. 21, 2025

Related U.S. Application Data
(60) Provisional application No. 63/410,540, filed on Sep. 27, 2022.

(51) Int. Cl. C08K 7/24; A47G 21/18

(52) U.S. Cl. CPC C08K 7/24; A47G 21/18; C08K 2201/005; C08K 2201/006

(57) ABSTRACT

The present specification generally relates to a composition for the manufacture of ocean degradable, bio-degradable, bio-compostable, biocompatible articles that contain a biopolymer. More specifically, the present invention relates to a biopolymer composition comprising: (i) a polyhydroxyalkanoate (PHA) in the range of 98% to about 60% by weight PHA, about 0% to about 40% by weight of an activated carbon material, and about 0-2% by weight nucleating agent of the total composition and the subsequent manufacture of articles formed using the biopolymer composition.

### BACKGROUND OF THE INVENTION

### 1. Field of the Invention

The present specification generally relates to environmentally compatible compositions and processing methods useful for the manufacture of polyhydroxyalkanoate-based articles and for increasing the desirable physical and mechanical properties of the manufactured polyhydroxyalkanoate-based articles. More specifically, the present invention relates to biopolymer composition comprising: (i) a polyhydroxyalkanoate (PHA) in the range of 98% to about 60% by weight PHA, about 0% to about 40% by weight of an activated carbon material, and about 0-2% by weight nucleating agent of the total composition and the subsequent manufacture of articles formed using the biopolymer composition of the present invention.

### 2. Description of the State of the Art

In the first decade of this century, more plastic was produced than all the plastic in history up to the year 2000. The use of plastic materials on a large scale has represented a mark in the history of technological development; however, the increasing utilization of these materials is resulting in serious environmental problems. These materials, in general, take approximately 500-1,000 years to degrade naturally, meaning that virtually every piece of synthetic plastic ever made still exists today in some shape or form. In the case of petrochemical-derived plastic resins, approximately 900 billion pounds worldwide are produced annually and it is estimated that this number will continue to increase each year by approximately four percent. Of this annual worldwide production, it is estimated that approximately 10 percent or 90 billion pounds enters the earth's oceans on an annual basis, resulting in the deaths of thousands of seabirds and sea turtles, seals and other marine mammals each year after either ingesting the plastic or getting entangled in it. Much of this waste results from single-use plastics, such as, but not limited to, the following products: (i) plastic bottles (more than 480 billion were sold worldwide in 2016); (ii) single-use plastic bags (about one trillion are used annually across the globe); (iii) plastic drinking straws (more than half a billion are used each day around the world); (iv) plastic cups (the world uses 500 billion every year); and (v) disposable plastic-laminated coffee cups (16 billion are used each year).

In view of these global volumes and associated problems, more than 60 countries have introduced levies and bans to combat single-use plastic waste, according to the U.N. Environment, an agency of the United Nations. Considering the relevance of these facts, the market potential for using environmentally safe materials is enormous and natural biodegradable plastic resins are receiving worldwide attention. The applications for these natural biodegradable biopolymers in the market involve products such as disposable materials, including, but not limited to, packaging, diapers, dishware, drinkware, drinking straws, cutlery, cosmetic, agrochemical and aquatic products, and medical and pharmaceutical articles, such as microencapsulating drugs of controlled release, medical sutures and fixation pins for bone fractures (due to their total biocompatibility and mild rejection from the receiving organism).

An important family of biodegradable biopolymers are polyhydroxyalkanoates (PHAs), which are polyesters naturally synthesized by over 300 different microorganisms, serving as natural energy reserves for the microbe. One of the simplest and most important polymers in the PHA biopolymer family is polyhydroxybutyrate (PHB). The commercial interest in PHBs is directly related not only to the biodegradability and biocompatibility characteristics but also to their thermo-mechanical properties and production costs. In addition, there is a growing body of evidence that PHBs, when ingested by an animal, can act as microbial control agents of the gut flora, which may have a positive impact on weight gain, growth rate and overall survival (Y. Duan, et al., Effect of dietary poly-b-hydroxybutyrate (PHB) on growth performance, intestinal health status and body composition of Pacific white shrimp Litopenaeus vannamei, Fish & Shellfish Immunology, 60:520-528 (2017); and E. H. Najdegerami, et al., Effects of poly-b-hydroxybutyrate (PHB) on Siberian sturgeon (Acipenser baerii) fingerlings performance and its gastrointestinal tract microbial community, FEMS Microbiol Ecol., 79:25-33 (2012). There are also many other kinds of PHAs, including PHBV, PHX, PHO, P4HB, P3HB4HB, and almost 200 other kinds, which may be produced in a range of microorganisms, including in microorganisms that consume methane, carbon dioxide, sugar, oil, intermediate substrates, monomers, and a variety of other carbon substrates.

These polyesters may be conveniently synthesized by cultivating a wide variety of microorganisms, bacteria in particular, in an aqueous medium on a carbon source, including sugars, alkanes, vegetable oils, organic acids, and alcohols. Depending on the microorganism, carbon source, nutrients, and culture conditions, PHA is typically stored inside of the living cell as discrete amorphous, water insoluble granules, can be difficult to isolate and purify. Once isolated, PHAs, such as PHB, can further suffer from brittleness, due to their semi-crystalline nature and thermal instability and only come in natural colors. One route to overcome the inherent brittleness of PHB is by producing copolymers, such as PHBV. These copolymers exhibit a lower melting point than PHB. Alternatively, the incorporation of rubber particles into a brittle thermoplastic matrix is known to improve the impact properties and the toughness of the polymer (Amos, J. L., et al., U.S. Pat. No. 2,694,692 (1954); and Baer, et al., U.S. Pat. No. 4,306,040 (1981)). Under proper conditions and using appropriate compatibilizers, synergistic effects arise to create high impact toughened polymer blends for high-value durable applications. But, adding low modulus rubber particles to the polymer lowers the stiffness and strength and this reduction in rigidity significantly lowers the scratch/mar resistance of the resulting blends. This problem has hindered the growth of rubber-toughened thermoplastics in the automotive industry. Hence, to overcome this brittleness, high modulus fillers like clay are also incorporated into the toughened blend which, with optimal processing and chemistry, can regain this lost strength and stiffness. Colorants may be added to provide consumers with color options other than the natural color of the material; however, many colorants come directly from petrochemical-based raw materials or from synthetically modified minerals which contain petroleum by products, whereas some activated carbon materials derived from natural materials are not derived from petroleum and thus when used would not release petroleum into the environment as the polymer biodegrades. Some activated carbon materials contain multivalent metals or are processed with high pH that cause degradation of PHB systems.

Thus, a need exists for (i) improving the durability, the flexibility, toughness, impact strength and/or oxygen moisture barrier properties of PHA's without the incorporation of rubber particles or the use of fillers such as clay; and (ii) providing a wide range of color choices without introducing the biopolymer to high pH during processing or introducing multivalent metals and petroleum products into an otherwise natural product, without further compromising PHA's inherent stiffness, strength, and its ability to biodegrade. Additionally, it is important to not incorporate materials having heavy metals, such as pigments, into the natural biopolymer composition of the present invention that have heavy metals as this has a detrimental impact on the ability for the article of manufacture to pass biodegradation studies.

### BRIEF SUMMARY OF THE INVENTION

The present invention addresses the need for (i) improving durability, toughness, impact strength, and/or oxygen moisture barrier properties of polyhydroxyalkanoate (PHA); and (ii) providing a color other than the natural color, without compromising the inherent stiffness, strength, and ability to biodegrade of the subsequent articles of manufacture that are formed using the biopolymer composition of the present invention.

The present invention further provides biopolymer compositions which are relatively inexpensive and easy to manufacture.

In general, the present invention describes an environmentally sustainable biopolymer composition, that is useful for the manufacture of polyhydroxyalkanoate-based articles. The articles of manufacture made using the biopolymer composition of the present invention, which is biodegradable, biocompatible and has nutritional value for any birds or animals that may happen to ingest it in whole or in part, comprises (i) a polyhydroxyalkanoate (PHA) in the range of 98% to about 94.8% by weight PHA, about 0% to about 5% by weight of an activated carbon material, and about 0-2% by weight nucleating agent of the total composition.

Also provided herein are methods of manufacturing articles via conventional techniques, such as but not limited to, extrusion, injection molding, etc., followed by a heating, cooling, or drying step which further effects the desirable physical and mechanical properties of the manufactured articles.

Also provided herein are activated carbon materials useful in the present invention having the following characteristics:
pH of the activated carbon materials is ideally in the range of 4.5-9, and preferably 5.5-7.5 based on the pH of 5 g of the powdered activated carbon materials dispersed in 100 ml of deionized water, preferably after stirring at room temperature for 12 hours. The pH is determined using a standard pH meter.
Particle size of 0.5-30 microns and preferably 1-5 microns.
Surface area between 300 and 2000 m2/g and preferably between 900 and 1500 m2/g, as measured by the Braeuer-Emmett-Teller (BET) method.

The 0.5-5 micron particle size may be obtained through any method of attrition such as but not limited to cryo-milling, jet milling, hammer milling, ball milling or bead milling but is most preferably obtained by submerging the activated carbon material in liquid nitrogen along with the grinding media at the bottom of the mill bowl at a temperature around-185° C. to −195.8° C. Alternatively, the particle sizes may be obtained by sieves in which the desired fractions are used.

The biopolymer compositions can be made by any suitable method, using any suitable order of processing. For example, in one embodiment, the method comprises the steps of: (a) mixing, in a molten state, the biopolymer composition; and (b) cooling the molten biopolymer composition to form a solid PHA polymer composition, which can then be blended with the activated carbon material and shaped into an article. Any suitable polymer processing equipment can be used such as, for example, an extruder (e.g., single screw or twin screw), electrostatic or melt-spun fiber production equipment, whether for woven or non-woven articles, or injection molding equipment. The methods can additionally comprise other steps, such as strand preparation, color addition, pelletizing and homogenizing.

In another embodiment, the biopolymer composition of the present invention is in the form of a fine particle size powder, and blended by dry-blending the activated carbon material and other desired components at a pre-determined ratio, mixed and processed. Again, any suitable processing equipment can be used, such as, for example, an extruder (e.g., single screw or twin screw). The methods can additionally comprise other steps, such as strand preparation, color addition, pelletizing and homogenizing the biopolymer composition. Additionally, the components may be blended in process, meaning they are added at set ratios during operation, such as through co-feeding, gravimetric feeding, and so forth.

In yet another embodiment, the biopolymer composition of the present invention

The novel biopolymer compositions of this invention can be fabricated into commercially useful articles, such as, but not limited to film, sheets, multi-layer structures, paper-based laminates, fiber, monofilaments, sheets, thermoformed articles, blow-molded articles, injection molded articles, extruded and injection stretch blow molding, and tubes, such as drinking straws, etc. Also provided herein are articles made from any of the biopolymer compositions of the invention.

Optionally, additives may be added to the biopolymer composition. Such additives may be mixed at a suitable time during the processing of the components for forming the blend composition. One or more additives are included in the biopolymer compositions to impart one or more selected functional characteristics to the biopolymer compositions and any article, molded, extruded or otherwise, made therefrom. Examples of additives that may be included in the present invention include, but are not limited to, absorbents, process stabilizers, light stabilizers, antioxidants, slip/antiblock agents, colorants, such as a pigment, a dye, a combination of pigments, a combination of dyes, a combination of pigments and a dye, a combination of a pigment and dyes, or a combination of pigments and dyes. The choice of colorants depends on the ultimate color desired by the designer for the plastic article.

UV absorbers, fillers, lubricants, pigments, dyes, colorants, flow promoters plasticizers, processing aids, branching agents, strengthening agents, nucleating agents (discussed in further detail below), talc, wax, calcium carbonate, radical scavengers, such as acid scavengers and scavengers designed to quench alkaline substances (AKA stabilizers), or a combination of one or more of the foregoing functional additives.

The fabricated articles of manufacture, as a waste product entering the environment, may then be used to benefit animal health and nutrition through the release of active natural polymers during the biodegradation process of the article of manufacture. As discussed previously activated carbon materials are not made from petroleum and activated carbon materials can be used that do not contain heavy metals thus these contaminants would not be released into the environment as the polymer biodegrades These natural polymers, such as, but not limited to, poly-3-hydroxybutyrate (PHB), can then be degraded into water-soluble short-chain fatty acid monomer which have been shown to be beneficial to growth performance, intestinal digestive and immune function.

In another embodiment, there is also provided a method for making biodegradable paper products with moisture barrier properties. The method includes providing a substrate having a front and back surface and extruding a barrier layer comprising the biopolymer composition of the present invention onto both the front and back surface of the substrate. The coat weight of the degradable material is within a range from 4 to 25 pounds per three-thousand square feet. Due to the coat weight, pinholes are typical and consequently a second layer can be extruded over the first layer or alternatively according to the methodology of the present invention the resulting paper having a coating can be formed into the desired product, such as but not limited to a cup, bowl, drinking straw, tray, etc. and then subjected to a post-manufacturing step wherein the product is heated to a temperature capable of melting the barrier allowing the barrier to flow into and fill any existing pinholes. Optionally, the resulting paper may also be additionally heated to homogenize and spread out the application of the first or second layer to reduce existing pinholes.

Additional embodiments and features are set forth in the description that follows, and in part will become apparent to those skilled in the art upon examination of the specification or may be learned by the practice of the disclosed embodiments. The features and advantages of the disclosed embodiments may be realized and attained by means of the instrumentalities, combinations, and methods described in the specification.

### BRIEF DESCRIPTION OF THE DRAWINGS

A further understanding of the nature and advantages of the disclosed embodiments may be realized by reference to the remaining portions of the specification and the drawings. All drawings are not to scale.

FIG. 1 is a description of the Flow Curve Analysis test the data of which is presented in FIG. 3.

FIG. 2 describes the Flow Curve Analysis that was conducted on the composition of the present invention. The flow curve of polymer melts is bound by two limiting slopes (dashed lines) which determine the zero-shear viscosity value (no) and the shear-thinning value (m).

FIG. 3 is a graphical representation of the data presented in Table 1 evaluating the shear rate dependency, of the biopolymer composition of the present invention in a molten state when exposed to a shear rate ramp from low to high shear rate typically 0.001 to 1000 (1/s) in rotary rheometer at high temperature for a certain time of testing.

While the invention is amenable to various modifications, specifics thereof have been shown by way of in the drawings and will be described in detail in the following more detailed description. It should be understood, however, that the intention is not to limit the invention to the particular embodiments described. On the contrary, the intention is to cover all modifications, equivalents, and alternatives falling within the spirit and scope of the invention as defined by the appended claims.

In the appended figures, similar components and/or features may have the same reference label. Further, various components of the same type may be distinguished by following the reference label by a dash and a second label that distinguishes among the similar components. If only the first reference label is listed in the specification, the description is applicable to anyone of the similar components having the same first reference label irrespective of the second reference label.

### DETAILED DESCRIPTION OF THE INVENTION

The present specification generally relates to a biopolymer composition useful for the manufacture of ocean degradable, bio-degradable, bio-compostable, biocompatible articles that contain a biopolymer component. In particular, it has been found, in accordance with the practice of this invention, that marked improvement in tensile strength, toughness, elongation and/or oxygen moisture barrier properties of the articles of manufacture formed are achieved when using the biopolymer composition of the present invention comprising: (i) a polyhydroxyalkanoate (PHA) in the range of 98% to about 60-% by weight PHA, about 0% to about 40% by weight of an activated carbon material, and about 0-2% by weight nucleating agent. More preferably, the PHA is in the range of range of 99.8% to about 85% by weight PHA, and more preferably in the range of range of 99.8% to about 94.8% by weight PHA, the activated carbon material is more preferably in the range of 0% to 14.8%, and more preferably in the range of 0% to about 5%, and the nucleating agents is in the range of 0-0.2%.

Surprisingly, it has been discovered that the typical brittle properties of a PHA material can be significantly altered by adding an activated carbon material having a critical set of characteristics, disclosed in further detail below. This was counterintuitive, as all previous studies and tests performed by the inventors introducing fillers and or minerals have led to increased rigidity and decreased flexibility in the articles of manufacture.

Activated carbon from pyrolyzed coconut husk is of neutral to low pH; however, it is manufactured to contain very large particle size with significant fractions >20 microns in max diameter. According to the present invention it has been discovered that it is advantageous to cryo-mill the activated carbon material to reduce the particle size while maintaining a low to neutral pH. The pH of the active carbon materials is ideally in the range of 4.5-9, and preferably 5.5-7.5 based on the pH of 5 g of the powdered activated carbon materials dispersed in 100 ml of deionized water, preferably after stirring at room temperature for 12 hours. It has been discovered that the particle size of the activated carbon material is most effective when less than 30 microns, more favorable under 15 microns, more favorably under 10 microns, and most favorably when less than 5 microns which provides a higher optical density, greater colorant covering power, and a smoother finish for the article of manufacture. In addition, it is advantageous to use an activated carbon material having a surface area between 300 and 2000 m2/g and preferably between 900 and 1500 m2/g, as measured by the Braeuer-Emmett-Teller (BET) method. These properties when combined enable a more ideal dispersion of black colorant, better coverage of black color, and increased opacity for food packaging applications most notably manufacturing of straws and thin films. Another advantage when using activated carbon from natural sources, such as but not limited to coconut husks, hemp, palm shells, bamboo waste, fruit seeds (“stones”), and jute fibers is that it provides a black colorant that does not introduce any petroleum or multi-valent metals into the biopolymer composition of the present invention. Consequently, as the article of manufacture degrades petroleum and heavy metal are not introduced into the environment.

Activated carbons can be classified by their surface area and by the size and volume of their internal pores. The pore structure can be characterized by relative percentages of three specific types of pore sizes.

Micro-pores: These pores are less than 2 nanometers (one nanometer is one billionth of one meter);

Meso-pores: These range in size from 2 to 50 nanometers; and

Macro-pores: The largest pores are from 50 to 2.00 nanometers (1,000 nanometers equals one micrometer).

The porosity of activated carbons can be characterized by the percentage of their total pore volume which falls withing the micropore size range (% micropores) and by the average pore diameter. The % micropores can be calculated by dividing the pore volume of the micro-pores by the total pore volume. Pore volumes and pore diameters can be obtained by nitrogen BET, mercury porosimetry, and other methods known in the art. The activated carbons useful in this invention have between 30% and 99% micropores, preferably between 85% and 98% micropores and will have average pore diameters of between 0.5 nm and 2.5 nm.

Activated carbons produced from coconut shells typically have very high surface area, very high % micropores, and very low pore diameters and have been found to be particularly useful in this invention.

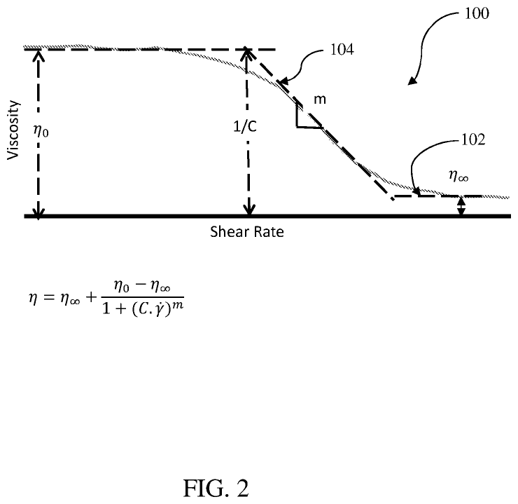

The activated carbon materials of this invention impart favorable rheological characteristics to the melted formulation which contributes to reduced brittleness of the melt processed articles. Surprisingly, melted formulations containing the activated carbon material of the present invention show an increased melt viscosity as well as increased Newtonian rheological behavior (a lower degree of shear thinning) at a melt state such as 185-195° C. over the same article/formulation without the activated carbon material. Thus, the activated carbon material can be considered to be a Newtonian thickener in such formulations, which is atypical for high surface area additives. All polymeric fluids exhibit a Newtonian plateau at low shear rate where their viscosity is maximum and starts to shear thin for value of shear rate larger than a critical value. As shown in FIG. 2, the flow curve of polymer melts 100 is bound by two limiting slopes 102 and 104 (dashed lines) which determine the zero-shear viscosity value (no) and the shear-thinning value (m), respectively. These parameters can be used to estimate molecular weight (Mw) as well as the breadth of the molecular weight distribution (MWD). Other factors that may have an effect on the shape of the viscosity-shear rate curve include pressure, temperature, filler, lubricant and plasticizer.

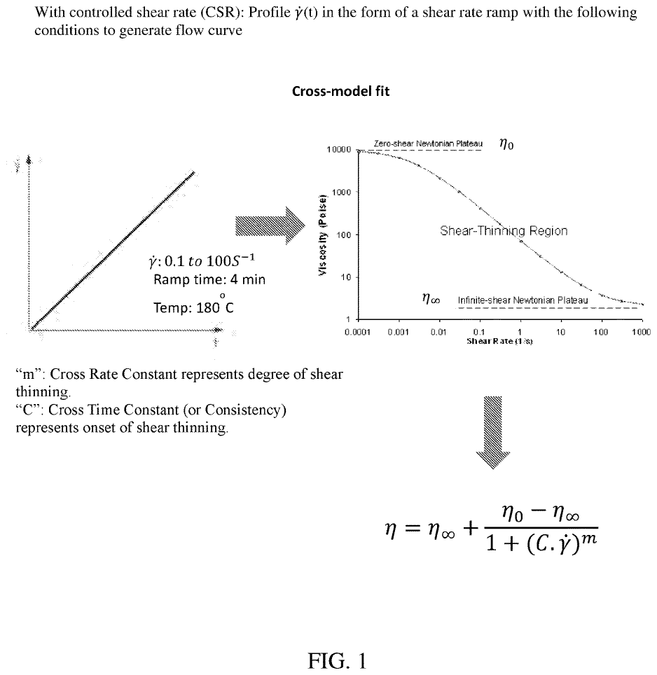

Several quantitative relationships have been defined in order to represent the shear rate dependency of viscosity of polymer materials. The Cross Fit model, graphically represented in FIG. 1 can be represented by the equation below has been developed for the biopolymer composition of the present invention:

$$η = {η}_{∞} + \frac{{η}_{0} - {η}_{∞}}{1 + {( C \cdot \dot{γ} )}^{m}}$$

To evaluate the shear rate dependency, the biopolymer composition of the present invention in a molten state was exposed to a shear rate ramp from low to high shear rate typically 0.001 to 1000 (1/s) in rotary rheometer at high temperature for a certain time of testing.

TABLE 1

| % Activated Carbon | η₀, Pa · s | C, s | m |
|---|---|---|---|
| 0% (control) | 1681.9 ± 735 | 0.075 ± 0.03 | 1.10 ± 0.21 |
| Non- cryo-milled 3% | 2393.3 ± 118 | 1.175 ± 0.12 | 0.102 ± 0.02 |
| Non- cryo-milled 1% | 1954.3 ± 116 | 1.163 ± 0.02 | 0.0652 ± 0.01 |
| Cryo-milled 3% | 2578.3 ± 82 | 1.116 ± 0.11 | 0.0458 ± 0.02 |
| Cryo-milled 1% | 2172 ± 110 | 1.126 ± 0.20 | 0.0423 ± 0.02 |

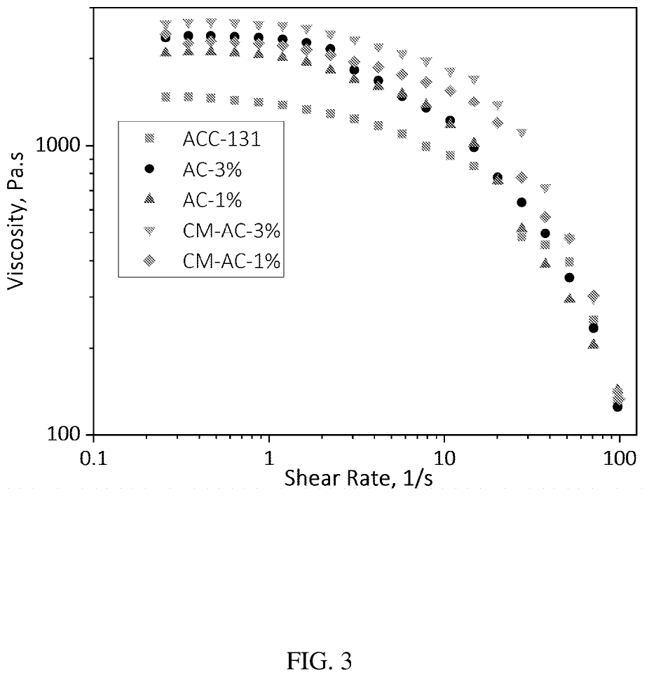

A value of zero for “m” indicates Newtonian behavior with “m” tending to unity for increasingly shear thinning behavior. As demonstrated in FIG. 3 and Table 1, all activated-carbon filled straws show strong Newtonian behavior compared to the control straws (absent of any activated carbon) which is more dominant for cryo-milled activated carbon.

All activated carbon filled straws show lower shear rate “1/C” for onset of shear thinning behavior in compared to control straws.

The present invention will become more clear from consideration of the following examples which are set forth to further illustrate the principles of the invention and are not intended, in any way, to be limitative thereof.

### Examples

### Application of the Biopolymer Composition

Provided herein is a method of forming a drinking straw using the biopolymer composition of the present invention. The method includes mixing: PHA, activated carbon, and a nucleating agent, under conditions sufficient to form a largely homogeneous composition; thereby forming a biopolymer composition that is capable of forming the desired article of manufacture. Alternatively, the PHA, in powder form, is fed into the hopper of an extrusion compounder that mixes, melts, and forms beads of the blended polymer. The PHA powder is melted as it travels down the barrel of the extruder. Special feeder screws are used to push the powder along its path. The molten polymer mixture is then squeezed out through a series of small holes at the other end of the extruder. One compounding method ejects these strands into cooling water where a series of rotating knives cut them into short pellets. The pellet shape is preferred for subsequent molding operations because pellets are easier to move than a fine powder. These pellets are then collected and dried; they may be further blended or coated with other additives before packaging. The finished biopolymer pellets are stored until they are ready to be molded into straws. This can also be performed to create a masterbatch. In this instance, the activated carbon is compounded with PHA powder, wherein the activated carbon is loaded at 10-25% preferably 15%. The maximum particle size of the activated carbon material should not exceed the wall thickness of the extruded article. Ideally, the maximum particle size would not exceed 20% of the wall thickness of the extruded article. The masterbatch is then mixed with PHA pellets at different loading dependent on formulation. For the masterbatch of activated carbon with PHA the loading is 0.67, 1.67, 3.33, 6.67, 20% preferably 20%. For the masterbatch of cryo-milled activated carbon with PHA the loading is 6.67, 3.33 and 0.67, and preferably 3.33%. A nucleating agent is included in the masterbatch, in the PHA pellets, or in both at a final concentration that is optimized to facile processing and optimal mechanical properties. A preferred nucleating agent is boron nitride. The mixture is then extruded to create a straw at varying process conditions, as discussed below. The additive(s) can also be prepared as a masterbatch for example, by incorporating the additive(s) in the biopolymer composition and producing pellets of the resultant composition for addition to subsequent processing. In a masterbatch the concentration of the additive(s) is (are) higher than the final amount for the product to allow for proportionate mixing of the additive in the final composition.

### Drinking Straw Extrusion

The biopolymer composition in pellet form is transferred to another extrusion profiler. The second extruder is fitted with a different type of die, which produces a hollow tube shape. The pellets are fed in a hopper on one end of the machine and are forced through a long channel by a screw mechanism. This screw is turned in the barrel with power supplied by a motor operating through a gear reducer. As the screw rotates, it moves the pellets down the barrel. As the pellets travels down the heated channel, it melts and becomes more flowable. By the time the pellets reach the end of the barrel, they are sufficiently melted and can be easily forced out through the opening in the die.

The pellets exit the die in a long string in the shape of a straw. It is then moved along by a piece of equipment known as a puller which helps maintain the shape of the straw as it is moved through the rest of the manufacturing process. Eventually, this elongated tube is directed through a cooling stage-usually a water bath. Ultimately, the long tubes are cut to the proper length by a knife tube to produce the desired length of straw. The thickness range (wall caliper) is typically about 0.001 inches-0.01 inches.

The straws formed using the biopolymer composition of the present invention were found to be far less brittle than the controls, that is, PHA without any activated carbon. The straws with activated carbon showed higher pass rate when a crush test was performed. The crush/chew test was performed using an Instron Single Column Universal Tester 6800 outfitted with a 1 kN load cell and a rubber tipped crush probe with a diameter of 1.1 cm. The crush probe repeatedly compressed the straw to a vertical displacement of 0.95× the outer diameter of the straw. The crush was repeated 8 times and the straw was rotated 90 degrees between each crush cycle. The straw was the visually examined. If a split, crack, break or lengthwise separation was evident to visual inspection, it was considered a “fail.” It is believed, without limiting the scope of the invention, that the change in viscosity of the polymer due to the surface area of the activated carbon, changed the drawdown ratio of the tube effecting PHB molecular alignment in the machine direction.

It is to be understood that throughout this specification when PHA is referred to it is contemplated that this term includes homopolymers, random co-polymers, impact co-polymers and blends thereof. As used herein, the terms “functional properties” and “functional characteristics” shall be given their ordinary meanings and shall also refer to the specification, features, qualities, traits, or attributes of PHA. The functional characteristics of the PHA include, but are not limited to molecular weight, polydispersity and/or polydispersity index, melt flow and/or melt index, monomer composition, co-polymer structure, melt index, non-PHA material concentration, purity, impact strength, density, specific viscosity, viscosity resistance, acid resistance, mechanical shear strength, flexular modulus, elongation at break, freeze-thaw stability, processing conditions tolerance, shelf-life/stability, hygroscopicity, and color. As used herein, the term “polydispersity index” (or PDI), shall be given its ordinary meaning and shall be considered a measure of the distribution of molecular mass of a given polymer sample (calculated as the weight average molecular weight divided by the number average molecular weight).

Polyhydroxyalkanoates are biological polyesters synthesized by a broad range of natural and genetically engineered microorganisms and microorganism enzymes as well as genetically engineered plant crops (Braunegg, et. al., J. Biotechnology, 65:127-161 (1998); Madison and Huisman, Microbiology and Molecular Biology Reviews, 63:21-53 (1999); Poirier, Progress in Lipid Research, 41:131-155 (2002)). These polymers are biodegradable materials, can be produced from renewable resources, and have the potential for use in a broad range of industrial applications (Williams & Peoples, CHEMTECH, 26:38-44 (1996)). Useful microbial strains for producing PHAs, include Cupriavidus necator (formerly known as Wautersia eutropha, Alcaligenes eutrophus (renamed as Ralstonia eutropha)), Alcaligenes latus, Aeromonas, Comamonas, Bacillus megaterium, Bacillus cereus SPV, Sinorhizobium meliloti, Azotobacter spp, Pseudomonas, and Methylosinus, spp Metylobacterium spp, and Methylococcus spp and genetically engineered organisms of the above mentioned microbes.

In general, a PHA is formed by enzymatic polymerization of one or more monomer units. Over 100 different types of monomers have been incorporated into the PHA polymers (Steinbuchel and Valentin, FEMS Microbiol. Lett., 128:219-228 (1995). Examples of monomer units incorporated in PHAs include 2-hydroxybutyrate, lactic acid, glycolic acid, 3-hydroxybutyrate (hereinafter referred to as 3HB), 3-hydroxypropionate (hereinafter referred to as 3HP), 3-hydroxyvalerate (hereinafter referred to as 3HV), 3-hydroxyhexanoate (hereinafter referred to as 3HH), 3-hydroxyheptanoate (hereinafter referred to as 3HHep), 3-hydroxyoctanoate (hereinafter referred to as 3HO), 3-hydroxynonanoate (hereinafter referred to as 3HN), 3-hydroxydecanoate (hereinafter referred to as 3HD), 3-hydroxydodecanoate (hereinafter referred to as 3HDd), 4-hydroxybutyrate (hereinafter referred to as 4HB), 4-hydroxyvalerate (hereinafter referred to as 4HV), 5-hydroxyvalerate (hereinafter referred to as 5HV), and 6-hydroxyhexanoate (hereinafter referred to as 6HH). 3-hydroxyacid monomers incorporated into PHAs are the (D) or (R) 3-hydroxyacid isomer with the exception of 3HP which does not have a chiral center.

The terms “PHA”, “PHAs”, and “polyhydroxyalkanoate”, as used herein, shall be given their ordinary meaning and shall include, but not be limited to, polymers generated synthetically and by microorganisms or microorganism enzymes; biodegradable and/or biocompatible polymers that can be used as alternatives to petrochemical-based plastics such as polypropylene, polyethylene, and polystyrene; polymers produced by bacterial fermentation of sugars, lipids, or gases; thermoplastic or elastomeric materials derived synthetically and from microorganisms or microorganism-derived enzymes; and/or polymers generated by chemical reaction not inside of microbial cell walls. PHAs include, but are not limited to, polyhydroxybutyrate (PHB), polyhydroxyvalerate (PHV), polyhydroxybutyrate-covalerate (PHBV), polyhydroxyhexanoate (PHHx) and blends thereof as discussed in detail below, as well as both short chain length (SCL), medium chain length (MCL), and long chain length (LCL) PHAs.

In some embodiments, the PHA is a homopolymer (all monomer units are the same).

Examples of PHA homopolymers include poly 3-hydroxyalkanoates (e.g., poly 3-hydroxypropionate (hereinafter referred to as P3HP), poly 3-hydroxybutyrate (hereinafter referred to as PHB) and poly 3-hydroxyvalerate), poly 4-hydroxyalkanoates (e.g., poly 4-hydroxybutyrate (hereinafter referred to as P4HB), or poly 4-hydroxyvalerate (hereinafter referred to as P4HV)) and poly 5-hydroxyalkanoates (e.g., poly 5-hydroxyvalerate (hereinafter referred to as P5HV)).

In certain embodiments, the starting PHA is a copolymer (containing two or more different monomer units) in which the different monomers are randomly distributed in the polymer chain. Examples of PHA copolymers include poly 3-hydroxybutyrate-co-3-hydroxypropionate (hereinafter referred to as PHB3HP), poly 3-hydroxybutyrate-co-4-hydroxybutyrate (hereinafter referred to as PHB4HB), poly 3-hydroxybutyrate-co-4-hydroxyvalerate (hereinafter referred to as PHB4HV), poly 3-hydroxybutyrate-co-3-hydroxyvalerate (hereinafter referred to as PHB3HV), poly 3-hydroxybutyrate-co-3-hydroxyhexanoate (hereinafter referred to as PHB3HH), poly 3-hydroxybutyrate-co-3-hydroxyvalerate-co-3-hydroxyhexanoate (hereinafter referred to as PHB3HV3HH), poly 3-hydroxybutyrate-co-4-hydroxyvalerate (hereinafter referred to as PHB4HV) and poly 3-hydroxybutyrate-co-5-hydroxyvalerate (hereinafter referred to as PHB5HV).

By selecting the monomer types and controlling the ratios of the monomer units in a given PHA copolymer a wide range of material properties can be achieved. Although examples of PHA copolymers having two different monomer units have been provided, the PHA can have more than two different monomer units (e.g., three different monomer units, four different monomer units, five different monomer units, six different monomer units). An example of a PHA having 4 different monomer units would be PHB-co-3HH-co-3HO-co-3HD or PHB-co-3-HO-co-3HD-co-3HDd (these types of PHA copolymers are hereinafter referred to as PHB3HX). Typically where the PHB3HX has 3 or more monomer units the 3HB monomer is at least 70% by weight of the total monomers, preferably 85% by weight of the total monomers, most preferably greater than 90% by weight of the total monomers for example 92%, 93%, 94%, 95%, 96% by weight of the copolymer and the HX comprises one or more monomers selected from 3HH, 3HO, 3HD, 3HDd.

The homopolymer (where all monomer units are identical) PHB and 3-hydroxybutyrate copolymers (PHB3HP, PHB4HB, PHB3HV, PHB4HV, PHB5HV, PHB3HHP, hereinafter referred to as PHB copolymers) containing 3-hydroxybutyrate and at least one other monomer are of particular interest for commercial production and applications. It is useful to describe these copolymers by reference to their material properties as follows. Type 1 PHB copolymers typically have a glass transition temperature (Tg) in the range of 6° C. to −10° C., and a melting temperature (TM) of between 80° C. to 180° C. Type 2 PHB copolymers typically have a Tg of −20° C. to −50° C. and TM of 55° C. to 90° C. and are based on PHB4HB, PHB5HV polymers with more than 15% 4HB, SHV, 6HH content or blends thereof. In particular embodiments, the Type 2 copolymer have a phase component with a Tg of −15° C. to −45° C. and no TM.

As used in the present invention, the molecular weight of PHA ranges between about 5,000,000 and about 2,500,000 Daltons, between about 2,500,000 and about 1,000,000 Daltons, between about 1,000,000 and about 750,000 Daltons, between about 750,000 and about 500,000 Daltons, between about 500,000 and about 250,000 Daltons, between about 250,000 and about 100,000 Daltons, between about 100,000 and about 50,000 Daltons, between about 50,000 and about 10,000 Daltons, and overlapping ranges thereof.

In determining the molecular weight, techniques such as multidetector gel permeation chromatography (GPC) can be used. The PHA can have a weight average molecular weight (in Daltons) of at least 500, at least 10,000, or at least 50,000 and/or less than 3,000,000, less than 2,000,000, less than 1,000,000, less than 1,500,000, and less than 800,000. In certain embodiments, preferably, the PHAs generally have a weight-average molecular weight in the range of 100,000 to 700,000. For example, the molecular weight range for PHB and Type 1 PHB copolymers for use in this application are in the range of 200,000 Daltons to 1.5 million Daltons as determined by GPC method and the molecular weight range for Type 2 PHB copolymers for use in the application 20,000 to 1.5 million Daltons.

In certain embodiments, the branched PHA, as discussed in further detail below, can have a weight average molecular weight of from about 150,000 Daltons to about 1,000,000 Daltons and a polydispersity index of from about 1.0 to about 8.0. As used herein, weight average molecular weight molecular weight are determined by multidetector gel permeation chromatography, using, e.g., chloroform or other suitable solvent as both the eluent and diluent for the PHA samples.

PHAs for use in the methods and compositions described in this invention are selected from PHB; a PHA blend of PHB with a Type 1 PHB copolymer where the PHB content by weight of PHA in the PHA blend is in the range of 5% to 95% by weight of the PHA in the PHA blend; a PHA blend of PHB with a Type 2 PHB copolymer where the PHB content by weight of the PHA in the PHA blend is in the range of 5% to 95% by weight of the PHA in the PHA blend; a PHA blend of a Type 1 PHB copolymer with a different Type 1 PHB copolymer and where the content of the first Type 1 PHB copolymer is in the range of 5% to 95% by weight of the PHA in the PHA blend; a PHA blend of a Type 1 PHB copolymer with a Type 2 PHA copolymer where the content of the Type 1 PHB copolymer is in the range of 30% to 95% by weight of the PHA in the PHA blend; a PHA blend of PHB with a Type 1 PHB copolymer and a Type 2 PHB copolymer where the PHB content is in the range of 10% to 90% by weight of the PHA in the PHA blend, where the Type 1 PHB copolymer content is in the range of 5% to 90% by weight of the PHA in the PHA blend and where the Type 2 PHB copolymer content is in the range of 5% to 90% by weight of the PHA in the PHA blend.

The nucleating agents of the biopolymer composition aid in the thermal conductivity of the present invention and comprises 0%-2.0% by weight of the total composition and preferably 0%-1.0%, more preferably 0%-0.1%, more preferably 0%-0.015%, and most preferably 0%-0.02% by weight of the total composition. In certain embodiments, the biopolymer composition and methods of the invention include one or more nucleating agents. Nucleating agents for various polymers are simple substances, metal compounds including composite oxides, for example, carbon black, calcium carbonate, synthesized silicic acid and salts, silica, zinc white, clay, kaolin, basic magnesium carbonate, boron nitride, cyanuric acid, mica, talc, quartz powder, diatomite, dolomite powder, titanium oxide, zinc oxide, antimony oxide, barium sulfate, calcium sulfate, alumina, calcium silicate, and metal salts of organophosphates; low-molecular organic compounds having a metal carboxylate group, for example, metal salts of such as octylic acid, toluic acid, heptanoic acid, pelargonic acid, lauric acid, myristic acid, palmitic acid, stearic acid, behenic acid, cerotic acid, montanic acid, melissic acid, benzoic acid, p-tert-butylbenzoic acid, terephthalic acid, terephthalic acid monomethyl ester, isophthalic acid, and isophthalic acid monomethyl ester; high-molecular organic compounds having a metal carboxylate group, for example, metal salts of such as: carboxyl-group-containing polyethylene obtained by oxidation of polyethylene; carboxyl-group-containing polypropylene obtained by oxidation of polypropylene; copolymers of olefins, such as ethylene, propylene and butene-1, with acrylic or methacrylic acid; copolymers of styrene with acrylic or methacrylic acid; copolymers of olefins with maleic anhydride; and copolymers of styrene with maleic anhydride; high-molecular organic compounds, for example: alpha-olefins branched at their 3-position carbon atom and having no fewer than 5 carbon atoms, such as 3,3 dimethylbutene-1,3-methylbutene-1,3-methylpentene-1,3-methylhexene-1, and 3,5,5-trimethylhexene-1; polymers of vinylcycloalkanes such as vinylcyclopentane, vinylcyclohexane, and vinylnorbornane; polyalkylene glycols such as polyethylene glycol and polypropylene glycol; poly(glycolic acid); cellulose; cellulose esters; and cellulose ethers; phosphoric or phosphorous acid and its metal salts, such as diphenyl phosphate, diphenyl phosphite, metal salts of bis(4-tert-butylphenyl) phosphate, and methylene bis-(2,4-tert-butylphenyl)phosphate; sorbitol derivatives such as bis(p-methylbenzylidene) sorbitol and bis(p-ethylbenzylidene) sorbitol; and thioglycolic anhydride, p-toluenesulfonic acid and its metal salts. Additionally, alumina trihydrate, wood, flour, ground walnut shells, coconut shells, activated carbon, coconut powder, rice husk shells and combinations thereof. The above nucleating agents may be used either alone or in combinations with each other.

### Additives

In certain embodiments, various additives are added to the biopolymer composition. Such additives may be mixed at a suitable time during the mixing of the components for forming the composition. The one or more additives are included in the biopolymer compositions to impart one or more selected characteristics to the biopolymer composition and any article made therefrom. Examples of additives that may be included in the present invention include, but arc not limited to, nucleating agents, process stabilizers, light stabilizers, antioxidants, slip/antiblock agents, pigments, UV absorbers, fillers, lubricants, pigments, dyes, colorants, flow promoters plasticizers, wax, calcium carbonate, radical scavengers, odor desiccant or a combination of one or more of the foregoing additives. The branching agent and/or cross-linking agent is added to one or more of these for easier incorporation into the polymer.

Optionally, additives are included in the biopolymer composition of the present invention at a concentration of about 0.05% to about 40% by weight of the total composition. For example, the range in certain embodiments is about 0.05% to about 20% of the total composition, more preferably 0.05% to about 10% of the total composition and most preferably about 0.05% to about 5% of the total composition. The additive is any compound known to those of skill in the art to be useful in the production of thermoplastics. Exemplary additives include, but are not limited to, plasticizers (e.g., to increase flexibility of a composition), antioxidants (e.g., to protect the composition from degradation by ozone or oxygen), ultraviolet stabilizers (e.g., to protect against weathering), lubricants (e.g., to reduce friction), pigments (e.g., to add color to the thermoplastic composition), flame retardants, fillers, reinforcing, mold release, and antistatic agents. It is well within the skilled practitioner's abilities to determine whether an additive should be included in the biopolymer composition of the present invention and, if so, what additive and the amount that should be added to the composition.

For purposes of this disclosure, the particle size and size distribution for natural fillers such as, but not limited to ground walnut shells, coconut shells, activated carbon, coconut powder, rice husk shells, will generally be described in terms of mesh sizes as measured using a generally conventional wet sieve analysis. A wet sieve analysis is a conventional process in which the activated carbon mixture is separated into ranges or “bins” based on particle size. In general, the activated carbon mixture is passed, with the aid of water, sequentially through a series of screens, each with progressively smaller openings typically ranging from 30 mesh (600 microns), 100 mesh (150 microns), down to a 500 mesh screen (25 microns). Particles larger than the opening size of a specific screen will remain atop that screen while smaller particles will pass through the screen to the next smaller screen. Particles smaller than the openings of 500 mesh screen are typically referred to as “fines” and these particles are analyzed by light scattering particle size analyzer. As an expedient, conventional mesh size notation will be used to refer to size ranges. More specifically, the notation “+” in front of a mesh size refers to particles too large to pass through a screen of the noted size. For example, +140 mesh refers to particles that are too large to pass through a screen of 140 mesh size. Similarly, the notation “−” in front of a mesh size refers to particles small enough to pass through a screen of the noted size. For example, −500 mesh refers to particles that are small enough to pass through a screen of 500 mesh size. Using this notation, the term “fines” refers to −500 mesh activated carbon particles. In referring to particle distributions, the notation “×” between two mesh sizes refers to a range of sizes. For example, 140×200 refers to a range or bin of activated carbon particle sizes smaller than 140 mesh and greater than 200 mesh. The optimal mesh size for use in the present invention is greater than 500 mesh (less than 25 micron). Particle sizes less than 25 micron maybe generated by using any of the particle generation methods known in the art, such as grinding, milling, cryo-milling, spray drying, freeze drying, jet milling, hammer milling, ball milling or bead milling, and other such methods. Alternatively, the particle sizes may be obtained by sieves in which the desired fractions are used.

The cumulative solid volume of particles is the combined volume of the particles in dry form in the absence of any other substance. The cumulative solid volume of the particles is determined by determining the volume of the particles before dispersing them in a polymer or liquid carrier by, for example, pouring them dry into a graduated cylinder or other suitable device for measuring volume. Alternatively, cumulative solid volume is determined by light scattering.

In certain embodiments, the biopolymer composition and methods of the invention include one or more surfactants. Surfactants are generally used to de-dust, lubricate, reduce surface tension, and/or densify. Examples of surfactants include, but are not limited to mineral oil, castor oil, and soybean oil. One mineral oil surfactant is DRAKEOL® 34 surfactant, available from Penreco (Dickinson, Tex., USA). MAXSPERSER W-6000 surfactant and W-3000 solid surfactants are available from Chemax Polymer Additives (Piedmont, S.C., USA). Non-ionic surfactants with HLB values ranging from about 2 to about 16 can be used, examples being TWEEN-20 surfactant, TWEEN-65 surfactant, Span-40 surfactant and Span 85 surfactant.

Anionic surfactants include: aliphatic carboxylic acids such as lauric acid, myristic acid, palmitic acid, stearic acid, and oleic acid; fatty acid soaps such as sodium salts or potassium salts of the above aliphatic carboxylic acids; N-acyl-N-methylglycine salts, N-acyl-N-methyl-beta-alanine salts, N-acylglutamic acid salts, polyoxyethylene alkyl ether carboxylic acid salts, acylated peptides, alkylbenzenesulfonic acid salts, alkylnaphthalenesulfonic acid salts, naphthalenesulfonic acid salt-formalin polycondensation products, melaminesulfonic acid salt-formalin polycondensation products, dialkylsulfosuccinic acid ester salts, alkyl sulfosuccinate disalts, polyoxyethylene alkylsulfosuccinic acid disalts, alkylsulfoacetic acid salts, (alpha-olefinsulfonic acid salts, N-acylmethyltaurine salts, sodium dimethyl 5-sulfoisophthalate, sulfated oil, higher alcohol sulfuric acid ester salts, polyoxyethylene alkyl ether sulfuric acid salts, secondary higher alcohol ethoxysulfates, polyoxyethylene alkyl phenyl ether sulfuric acid salts, monoglysulfate, sulfuric acid ester salts of fatty acid alkylolamides, polyoxyethylene alkyl ether phosphoric acid salts, polyoxyethylene alkyl phenyl ether phosphoric acid salts, alkyl phosphoric acid salts, sodium alkylamine oxide bistridecylsulfosuccinates, sodium dioctylsulfosuccinate, sodium dihexylsulfosuccinate, sodium dicyclohexylsulfosuccinate, sodium diamylsulfosuccinate, sodium diisobutylsulfosuccinate, alkylamine guanidine polyoxyethanol, disodium sulfosuccinate ethoxylated alcohol half esters, disodium sulfosuccinate ethoxylated nonylphenol half esters, disodium isodecylsulfosuccinate, disodium N-octadecylsulfosuccinamide, tetrasodium N-(1,2-dicarboxyethyl)-N-octadecylsulfosuccinamide, disodium mono- or didodecyldiphenyl oxide disulfonates, sodium diisopropylnaphthalenesulfonate, and neutralized condensed products from sodium naphthalenesulfonate.

One or more lubricants can also be added to the compositions and methods of the invention. Lubricants are normally used to reduce sticking to hot metal surfaces during processing and can include polyethylene, paraffin oils, and paraffin waxes in combination with metal stearates (e.g., zinc sterate). Other lubricants include stearic acid, amide waxes, ester waxes, metal carboxylates, and carboxylic acids. Lubricants are normally added to polymers in the range of about 0.1 percent to about 1 percent by weight, generally from about 0.7 percent to about 0.8 percent by weight of the compound. Solid lubricants are warmed and melted before or during processing of the blend.

One or more anti-microbial agents can also be added to the compositions and methods of the invention. An anti-microbial is a substance that kills or inhibits the growth of microorganisms such as bacteria, fungi, or protozoans, as well as destroying viruses. Antimicrobial drugs either kill microbes (microbicidal) or prevent the growth of microbes (microbistatic). A wide range of chemical and natural compounds are used as antimicrobials, including but not limited to: organic acids, essential oils, cations and elements (e.g., colloidal silver and zinc-based materials). Commercial examples include but are not limited to PolySept® Z microbial, UDA and AGION®. PolySept® Z microbial (available from PolyChem Alloy) is an organic salt based, non-migratory antimicrobial. “UDA” is Urtica dioica agglutinin. AGION® antimicrobial is a silver compound. AMICAL® 48 silver is diiodomethyl p-tolyl sulfone.

Suitable heat stabilizers include, for example, organo phosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, phosphates such as trimethyl phosphate, or the like, or combinations including at least one of the foregoing heat stabilizers. Heat stabilizers are generally used in amounts of from 0.01 to 0.5 parts by weight based on 100 parts by weight of the total composition, excluding any filler.

Suitable antioxidants include, for example, organophosphites such as tris(nonyl phenyl)phosphite, tris(2,4-di-t-butylphenyl)phosphite, bis(2,4-di-t-butylphenyl) pentaerythritol diphosphite, distearyl pentaerythritol diphosphite or the like; alkylated monophenols or polyphenols; alkylated reaction products of polyphenols with dienes, such as tetrakis[methylene (3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl) propionate, pentaerythrityl-tetrakis[3-(3,5-di-tert-butyl-4-hydroxyphenyl) propionate or the like; amides of beta-(3,5-di-tert-butyl-4-hydroxyphenyl)-propionic acid or the like, or combinations including at least one of the foregoing antioxidants. Antioxidants are generally used in amounts of from 0.01 to 0.5 parts by weight, based on 100 parts by weight of the total composition, excluding any filler.

Suitable light stabilizers include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone or the like or combinations including at least one of the foregoing light stabilizers. Light stabilizers are generally used in amounts of from 0.1 to 1.0 parts by weight, based on 100 parts by weight of the total composition, excluding any filler.

Suitable antistatic agents include, for example, glycerol monostearate, sodium stearyl sulfonate, sodium dodecylbenzenesulfonate or the like, or combinations of the foregoing antistatic agents. In one embodiment, carbon fibers, carbon nanofibers, carbon nanotubes, carbon black, or any combination of the foregoing may be used in a biopolymeric pellets containing chemical antistatic agents to render the composition electrostatically dissipative.

Suitable mold releasing agents include for example, metal stearate, stearyl stearate, pentaerythritol tetrastearate, beeswax, montan wax, paraffin wax, or the like, or combinations including at least one of the foregoing mold release agents. Mold releasing agents are generally used in amounts of from 0.1 to 1.0 parts by weight, based on 100 parts by weight of the total composition, excluding any filler.

Suitable UV absorbers include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB® 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenyl-acryloyl)oxy]methyl]propane (UVINUL® 3030); 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenyl-acryloyl)oxy]methyl]propane; nano-size inorganic materials such as titanium oxide, cerium oxide, and zinc oxide, all with particle size less than 100 nanometers; or the like, or combinations including at least one of the foregoing UV absorbers. UV absorbers are generally used in amounts of from 0.01 to 3.0 parts by weight, based on 100 parts by weight of the total composition, excluding any filler.

Suitable blowing agents include for example, low boiling halohydrocarbons and those that generate carbon dioxide; blowing agents that are solid at room temperature and when heated to temperatures higher than their decomposition temperature, generate gases such as nitrogen, carbon dioxide, ammonia gas, such as azodicarbonamide, metal salts of azodicarbonamide, 4,4′ oxybis(benzenesulfonylhydrazide), sodium bicarbonate, ammonium carbonate, or the like, or combinations including at least one of the foregoing blowing agents. Blowing agents are generally used in amounts of from 1 to 20 parts by weight, based on 100 parts by weight of the total composition, excluding any filler.

Additionally, materials to improve flow and other properties may be added to the composition, such as low molecular weight hydrocarbon resins. Particularly useful classes of low molecular weight hydrocarbon resins are those derived from petroleum C5 to C9 feedstock that are derived from unsaturated C5 to C9 monomers obtained from petroleum cracking. Non-limiting examples include olefins, e.g., pentenes, hexenes, heptenes and the like; diolefins, e.g., pentadienes, hexadienes and the like; cyclic olefins and diolefins, e.g., cyclopentene, cyclopentadiene, cyclohexene, cyclohexadiene, methyl cyclopentadiene and the like; cyclic diolefin dienes, e.g., dicyclopentadiene, methylcyclopentadiene dimer and the like; and aromatic hydrocarbons, e.g. vinyltoluenes, indenes, methylindenes and the like. The resins can additionally be partially or fully hydrogenated.

### Branched Polyhydroxyalkanoates

The term “branched PHA” refers to a PHA with branching of the chain and/or cross-linking of two or more chains. Branching on side chains is also contemplated. Branching can be accomplished by various methods. The PHAs described previously can be branched by branching agents by free-radical-induced cross-linking of the polymer. In certain embodiment, the PHA is branched prior to combination in the method. In other embodiments, the PHA is reacted with peroxide in the methods of the invention. The branching increases the melt strength of the polymer. PHA can be branched in any of the ways described in U.S. Pat. Nos. 6,620,869, 7,208,535, 6,201,083, 6,156,852, 6,248,862, 6,201,083 and 6,096,810 all of which are incorporated herein by reference in their entirety.

The polymers of the invention can also be branched according to any of the methods disclosed in International Publication No. WO 2010/008447, titled “Methods For Branching PHA Using Thermolysis” or International Publication No. WO 2010/008445, titled “Branched PHA Compositions, Methods for Their Production, and Use in Applications,” both of which were published in English on Jan. 21, 2010, and designated the United States. These applications are incorporated by reference herein in their entirety.

### Branching Agents

The branching agents, also referred to a free radical initiator, for use in the compositions and methods described herein include organic peroxides. Peroxides are reactive molecules, and can react with linear PHA molecules or previously branched PHA by removing a hydrogen atom from the polymer backbone, leaving behind a radical. PHA molecules having such radicals on their backbone are free to combine with each other, creating branched PHA molecules. Branching agents are selected from any suitable initiator known in the art, such as peroxides, azo-dervatives (e.g., azo-nitriles), peresters, and peroxycarbonates. Suitable peroxides for use in the present invention include, but are not limited to, organic peroxides, for example dialkyl organic peroxides such as 2,5-dimethyl-2,5-di(t-butylperoxy) hexane, 2,5-bis(t-butylperoxy)-2,5-dimethylhexane (available from Akzo Nobel as TRIGANOX 101), 2,5-dimethyl-di(t-butylperoxy) hexyne-3, di-t-butyl peroxide, dicumyl peroxide, benzoyl peroxide, di-t-amyl peroxide, t-amylperoxy-2-ethylhexylcarbonate (TAEC), t-butyl cumyl peroxide, n-butyl-4,4-bis(t-butylperoxy) valerate, 1,1-di(t-butylperoxy)-3,3,5-trimethyl-cyclohexane, 1,1-bis(t-butylperoxy)-3,3,5-trimethylcyclohexane (CPK), 1,1-di(t-butylperoxy)cyclohexane, 1,1-di(t-amylperoxy)-cyclohexane, 2,2-di(t-butylperoxy) butane, ethyl-3,3-di(t-butylperoxy) butyrate, 2,2-di(t-amylperoxy) propane, ethyl-3,3-di(t-amylperoxy) butyrate, di-(tert-butylperoxyisopropyl)benzene (VulCup®), t-butylperoxy-acetate, t-amylperoxyacetate, t-butylperoxybenzoate, t-amylperoxybenzoate, di-t-butyldiperoxyphthalate, and the like. Combinations and mixtures of peroxides can also be used. Examples of free radical initiators include those mentioned herein, as well as those described in, e.g., Polymer Handbook, 3rd Ed., J. Brandrup & E. H. Immergut, John Wiley and Sons, 1989, Ch. 2. Irradiation (e.g., e-beam or gamma irradiation) can also be used to generate PHA branching.

### Cross-Linking Agents

Cross-linking agents, also referred to as co-agents, used in the methods and compositions of the invention are cross-linking agents comprising two or more reactive functional groups such as epoxides or double bonds. These cross-linking agents modify the properties of the polymer. These properties include, but are not limited to, melt strength or toughness. One type of cross-linking agent is an “epoxy functional compound.” As used herein, “epoxy functional compound” is meant to include compounds with two or more epoxide groups capable of increasing the melt strength of polyhydroxyalkanoate polymers by branching, e.g., end branching as described above.

When an epoxy functional compound is used as the cross-linking agent in the disclosed methods, a branching agent is optional. As such one embodiment of the invention is a method of branching a starting PHA, comprising reacting a starting PHA with an epoxy functional compound. Alternatively, the invention is a method of branching a starting polyhydroxyalkanoate polymer, comprising reacting a starting PHA, and an epoxy functional compound in the absence of a branching agent. Such epoxy functional compounds can include epoxy-functional, styrene-acrylic polymers (such as, but not limited to, e.g., MP-40 (Kaneka)), acrylic and/or polyolefin copolymers and oligomers containing glycidyl groups incorporated as side chains (poly(ethylene-glycidyl methacrylate-co-methacrylate)), and epoxidized oils (such as, but not limited to, e.g., epoxidized soybean, olive, linseed, palm, peanut, coconut, seaweed, cod liver oils, or mixtures thereof, e.g., Merginat® ESBO (Hobum, Hamburg, Germany) and EDENOL® B 316 (Cognis, Dusseldorf, Germany)).

For example, reactive acrylics or functional acrylics cross-linking agents are used to increase the molecular weight of the polymer in the branched polymer compositions described herein. Such cross-linking agents are sold commercially. One such compound is MP-40 (Kaneka) and still another is Petra line from Honeywell, see for example, U.S. Pat. No. 5,723,730. Such polymers are often used in plastic recycling (e.g., in recycling of polyethylene terephthalate) to increase the molecular weight (or to mimic the increase of molecular weight) of the polymer being recycled.

E.I. du Pont de Nemours & Company sells multiple reactive compounds such as ethylene copolymers, such as acrylate copolymers, elastomeric terpolymers, and other copolymers. Omnova sells similar compounds under the trade names “SX64053,” “SX64055,” and “SX64056.” Other entities also supply such compounds commercially.

Specific polyfunctional polymeric compounds with reactive epoxy functional groups are the styrene-acrylic copolymers. These materials are based on oligomers with styrene and acrylate building blocks that have glycidyl groups incorporated as side chains. A high number of epoxy groups per oligomer chain are used, for example 5, greater than 10, or greater than 20. These polymeric materials generally have a molecular weight greater than 3000, specifically greater than 4000, and more specifically greater than 6000. Other types of polyfunctional polymer materials with multiple epoxy groups are acrylic and/or polyolefin copolymers and oligomers containing glycidyl groups incorporated as side chains. These materials can further comprise methacrylate units that are not glycidyl. An example of this type is poly(ethylene-glycidyl methacrylate-co-methacrylate).

Fatty acid esters or naturally occurring oils containing epoxy groups (epoxidized) can also be used. Examples of naturally occurring oils are olive oil, linseed oil, soybean oil, palm oil, peanut oil, coconut oil, seaweed oil, cod liver oil, or a mixture of these compounds. Particular preference is given to epoxidized soybean oil (e.g., Merginat® ESBO from Hobum, Hamburg, or EDENOL® B 316 from Cognis, Dusseldorf), but others may also be used.

Another type of cross-linking agent are agents with two or more double bonds. Cross-linking agents with two or more double bond cross-link PHAs by after reacting at the double bonds. Examples of these include: diallyl phthalate, pentaerythritol tetraacrylate, trimethylolpropane triacrylate, pentaerythritol triacrylate, dipentaerythritol pentaacrylate, diethylene glycol dimethacrylate, bis(2-methacryloxyethyl)phosphate.

In general, it appears that compounds with terminal epoxides may perform better than those with epoxide groups located elsewhere on the molecule.

Compounds having a relatively high number of end groups are the most desirable. Molecular weight may also play a role in this regard, and compounds with higher numbers of end groups relative to their molecular weight (e.g., the Joncryl® resins are in the 3000-4000 g/mol range) are likely to perform better than compounds with fewer end groups relative to their molecular weight (e.g., the Omnova products have molecular weights in the 100,000-800,000 g/mol range).

In certain embodiments, the biopolymer composition is made by melt mixing the individual components to produce a homogeneous mixture. The mixture is then used for conversion into fabricated parts through sheet or melt extrusion, fiber extrusion, cast film extrusion, and blown film extrusion. For the purposes of the present invention, the term “extrusion” refers to a method for shaping, molding, forming, etc., a material by forcing, pressing, pushing, etc., the material through a shaping, forming, etc., device having an orifice, slit, etc., for example, a die, etc. Extrusion may be continuous (producing indefinitely long material) or semi-continuous (producing many short pieces, segments, etc.). For film applications the composition of the invention may be the complete film or one or more layers in a multilayer co-extruder composite structure. Alternatively, the biopolymer composition may form different layers on a substrate, where each layer has a slightly different composition.

Additionally, provided herein is a method for forming a biopolymer pellet, where the method includes combining: (i) a polyhydroxyalkanoate (PHA) in the range of 99.8% to about 94.8% by weight PHA, about 0% to about 5% by weight of an activated carbon material, and about 0-0.2% by weight nucleating agent of the total composition, wherein the composition is later melted and formed under suitable conditions to form a resin pellet which is subsequently processed into extruded straws, to film, sheets, multi-layer structures, paper-based laminates, fiber, monofilaments, sheets, thermoformed articles, blow-molded articles, injection molded articles, extruded and injection stretch blow molding etc.

In any of the compositions, methods, processes or articles described herein, the polyhydroxyalkanoate (PHA) in the range of range of 98% to about 60% by weight PHA, about 0% to about 40% by weight of an activated carbon material, and about 0-2% by weight nucleating agent by weight of the total composition, can be in the form of a fine particle size powder, pellet, or granule and combined by mixing or blending. More preferably, the PHA is in the range of range of 99.8% to about 85% by weight PHA, and more preferably in the range of range of 99.8% to about 94.8% by weight PHA, the activated carbon material is more preferably in the range of 0% to 14.8%, and more preferably in the range of 0% to about 5%, and the nucleating agent is more preferably in the range 0% to 1%, and more preferably in the range of 0% to 0.2%.

It would be understood by one skilled in the art that the PHA film compositions of the present invention may include a number of additives or other components which are commonly included in polymeric films without departing from the spirit and scope of the present invention. These may include, for example, dyes, fillers, stabilizers, modifiers, anti-blocking additives, antistatic agents etc.

The novel biopolymer compositions described herein can be fabricated into commercially useful articles, such as, but not limited to, films; sheets (including multilayer sheets); cutlery; drinking straws; fiber; paper based laminates, which can further be converted in drinking straws, cups, bowls, containers; nonwovens; filaments; monofilaments; rod; tubes; bottles; pellets; or foams. The article is formed by molding, extruding, thermoforming or blowing of the biopolymer composition.

For the fabrication of useful articles, the compositions described herein are processed preferably at a temperature above 125° C. but below the decomposition point of any of the ingredients (e.g., the additives described above, with the exception of some branching agents) of the aliphatic polyester resin composition. While in heat plasticized condition, the biopolymer composition is processed into a desired shape, and subsequently cooled to set the shape and induce crystallization. Such shapes can include, but are not limited to, a fiber, filament, nonwovens, monofilaments, film, sheet, rod, tube, drinking straw, bottle, paper based laminates, or other shape. Such processing is performed using any art-known technique, such as, but not limited to, extrusion, injection molding, compression molding, blowing or blow molding (e.g., blown film, blowing of foam), calendaring, rotational molding, casting (e.g., cast sheet, cast film), or thermoforming.

The compositions are used to create, without limitation, a wide variety of useful products, e.g., single-use plastic articles, automotive, consumer durable, construction, electrical, medical, and packaging products all of which can secondarily be used as animal feed. For instance, the biopolymer compositions is used to make, without limitation, films (e.g., packaging films, agricultural film, mulch film, erosion control, hay bale wrap, slit film, food wrap, pallet wrap, protective automobile and appliance wrap, etc.), golf tees, caps and closures, agricultural supports and stakes, paper and board coatings (e.g., for drinking straws, cups, plates, boxes, etc.), thermoformed products (e.g., trays, containers, lids, yoghurt pots, cup lids, plant pots, noodle bowls, moldings, etc.), housings (e.g., for electronics items, e.g., cell phones, PDA cases, music player cases, computer cases and the like), bags (e.g., trash bags, grocery bags, food bags, compost bags, etc.), hygiene articles (e.g., diapers, feminine hygiene products, incontinence products, disposable wipes, etc.), coatings for pelleted products (e.g., pelleted fertilizer, herbicides, pesticides, seeds, etc.), injection molded articles (writing instruments, cutlery, such as forks, spoons and knifes, aquarium decorations, disk cases, etc.), solution and spun fibers and melt blown fabrics and non-wovens (threads, yarns, wipes, wadding, disposable absorbent articles), blow moldings (deep containers, bottles, etc.), extruded articles, such as drinking straws, and foamed articles (cups, bowls, plates, packaging, etc.). The products disclosed above all contain a major component (PHA) which if ingested by an animal can be metabolized by the animal and used as a source of energy. Consequently, the added benefit of the products is that they also serve as a food product for living organisms. The term animal includes all animals including human. Examples of animals are non-ruminants, and ruminants. Ruminant animals include, for example, animals such as sheep, goat, and cattle, e.g. cow such as beef cattle and dairy cows. In a particular embodiment, the animal is a non-ruminant animal. Non-ruminant animals include pet animals, e.g. horses, cats and dogs; mono-gastric animals, e.g., pig or swine (including, but not limited to, piglets, growing pigs, and sows); poultry such as turkeys, ducks and chickens (including but not limited to broiler chicks, layers); fish (including but not limited to salmon, trout, tilapia, catfish and carp); seabirds (including but not limited to seagulls, pelicans, terns) sea animals (including but not limited to whales, turtles, dolphins, sharks) and crustaceans (including but not limited to shrimp and prawn).

Thermoforming is a process that uses films or sheets of thermoplastic. The biopolymer composition is processed into a film or sheet. The sheet of polymer is then placed in an oven and heated. When soft enough to be formed it is transferred to a mold and formed into a shape.

During thermoforming, when the softening point of a semi-crystalline polymer is reached, the polymer sheet begins to sag. The window between softening and droop is usually narrow. It can therefore be difficult to move the softened polymer sheet to the mold quickly enough. Branching the polymer can be used to increase the melt strength of the polymer so that the sheet maintains is more readily processed and maintains its structural integrity. Measuring the sag of a sample piece of polymer when it is heated is therefore a way to measure the relative size of this processing window for thermoforming.

Blow molding, which is similar to thermoforming and is used to produce deep draw products such as drinking straws, and bottles and similar products with deep interiors, also benefits from the increased elasticity and melt strength and reduced sag of the polymer compositions described herein.

Extrusion molding is a process used to make pipes, hoses, drinking straws, and the like. Essentially, pellets are melted into a flowable liquid which is forced through a die, forming a long tube like shape. The shape of the die determines the shape of the tube or straw. The straw is then moved along by a piece of equipment known as a puller which helps maintain the shape of the straw as it is moved through the rest of the manufacturing process. In some processes, it is necessary to pull the straw through special sizing plates to better control the diameter. These plates are essentially metal sheets with holes drilled in them. Eventually, this elongated tube is directed through a cooling stage, usually a water bath. Some operations run the plastic over a chilled metal rod, called a mandrel, which freezes the internal dimension of the straw to that of the rod. Ultimately, the long tubes are cut to the proper length by a knife assembly.

Similar to extrusion molding is extrusion coating wherein a coating of a molten web of resin onto a substrate material such as but not limited to paperboard, corrugated fiberboard, paper, aluminum foils, cellulose, or non-wovens. Paper-based laminates for food service using the composition of the present invention are contemplated in order to hold liquids for a longer period of time without leaking or becoming soft as is common with 100% paper cups and paper drinking straws.

Without further elaboration, it is believed that one skilled in the art can, based on the description herein, utilize the present invention to its fullest extent. All publications cited herein are hereby incorporated by reference in their entirety.

Having disclosed several embodiments, it will be recognized by those skilled in the art that various modifications, alternative constructions, and equivalents may be used without departing from the spirit of the disclosed embodiments. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the dielectric material” includes reference to one or more dielectric materials and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A biopolymer composition comprising a polyhydroxyalkanoate (PHA) in the range of 98% to about 60% by weight PHA, about 0% to about 40% by weight of an activated carbon material, and about 0-2% by weight nucleating agent by weight of the total composition.

2. The biopolymer composition of claim 1, wherein the weight of said polyhydroxyalkanoate is about 60%, said activated carbon material is about 39.9% by weight, and said nucleating agent is about 0.1% by weight with respect to 100 parts by weight of the total biopolymer composition.

3. The biopolymer composition of claim 1, wherein the weight of said polyhydroxyalkanoate is about 84.9%, said activated carbon material is about of 15% by weight, and said nucleating agent is about 0.1% by weight with respect to 100 parts by weight of the total biopolymer composition

4. The biopolymer composition of claim 1, wherein the weight of said polyhydroxyalkanoate is about 94.9%, said activated carbon material is about of 5% by weight, and said nucleating agent is about 0.1% by weight with respect to 100 parts by weight of the total biopolymer composition.

5. The biopolymer composition of claim 1, wherein the weight of said polyhydroxyalkanoate is about 96.9%, said activated carbon material is about of 3% by weight, and said nucleating agent is about 0.1% by weight with respect to 100 parts by weight of the total biopolymer composition.

6. The biopolymer composition of claim 1, wherein the weight of said polyhydroxyalkanoatc is about 96.9%, said activated carbon material is about of 3% by weight, and said nucleating agent is about 0.1% by weight with respect to 100 parts by weight of the total biopolymer composition.

7. The biopolymer composition of claim 1, wherein the weight of said polyhydroxyalkanoate is about 97% and said activated carbon material is about of 3% by weight with respect to 100 parts by weight of the total biopolymer composition.

8. The biopolymer composition of claim 1, when melted with 0.1-5% of the activated carbon material shows increased Newtonian rheological behavior (a lower degree of shear thinning) at a melt state such as 185-195° C. and a higher melt viscosity over the same article/formulation without said activated carbon material.

9. The biopolymer composition of claim 1, wherein the cross-rate constant for shear thinning for the melted biopolymer composition having a with 0.1-5% of said activated carbon material is less than 70% of the value of the same article/formulation without said activated carbon material.

10. The biopolymer composition of any of claims 1-9, wherein said activated carbon material is coconut husk.

11. The biopolymer composition of any of claims 1-9, wherein said activated carbon material is hemp.

12. The biopolymer composition of claim 10, wherein said activated coconut husk has a surface area of 900-1500 m2/g.

13. The biopolymer composition of claim 12, wherein said activated coconut husk has a pH of 5.5-7.5.

14. The biopolymer composition of claim 13, wherein said activated coconut husk is in a particulate form and has a particle size of 0.5-5 microns.

15. The biopolymer composition of claim 14, wherein said activated coconut husk has a microporosity percentage of 85-98%.

16. The biopolymer composition of any of claims 1-15, wherein said polyhydroxyalkanoate has a weight-average molecular weight of about 100,000 to 1,000,000 Daltons.

17. A drinking straw formed from the biopolymer composition of any of claims 1-16.

18. The drinking straw of claim 17, having a sidewall thickness of 0.001 inches-0.010 inches.

19. The drinking straw of claim 17 or 18, wherein said particle size of said activated carbon material does not exceed said sidewall thickness by greater than 20 percent.

20. The biopolymer composition of any of claims 1-16, wherein said nucleating agent is cyanuric acid, boron nitride, activated carbon, carbon black, mica, talc, silica, clay, calcium carbonate, synthesized silicic acid and salts, metal salts of organophosphates, kaolin, and combinations thereof.

21. A Newtonian thickener for use in PHA formulations.

22. The Newtonian thickener of claim 21, wherein said Newtonian thickener is an activated carbon material.

23. The Newtonian thickener of claim 22, wherein said activated carbon material is derived from coconut husk, hemp, palm shells, bamboo waste, fruit seeds (“stones”).

24. The Newtonian thickener of claim 22 or 23, wherein said activated carbon material is coconut husk.

25. The Newtonian thickener of any of claims 22-24, wherein said activated carbon has a particle size in the range of 0.5-3.0 microns.

26. The Newtonian thickener of any of claims 24-25, wherein said activated coconut husk has a particle size in the range of 0.5-5.0 microns, a surface area between 900 and 1500 m2/g, and a pH between 5.5 and 7.5.

27. The Newtonian thickener of any of claims 24-26, wherein said activated coconut husk has a particle size in the range of 0.5-30 microns, a surface area between 900 and 1500 m2/g, and a pH between 5.5 and 7.5.
